(19) United States
(12) Patent Application Publication
(10) Pub. No.: US 2024/0235870 A1
(43) Pub. Date: Jul. 11, 2024

(54) VIRTUAL MEETING CONFIGURATION AND EXECUTION TEMPLATES

(71) Applicant: Zoom Video Communications, Inc., San Jose, CA (US)

(72) Inventor: Tania Sung-Yi CHEN, Cupertino, CA (US)

(73) Assignee: Zoom Video Communications, Inc., San Jose, CA (US)

(21) Appl. No.: 18/094,075

(22) Filed: Jan. 6, 2023

(51) Int. Cl. H04L 12/18; G06F 40/58; G10L 15/26

(52) U.S. Cl. CPC H04L 12/1822; G06F 40/58; G10L 15/26

(57) ABSTRACT

Systems and methods for providing virtual meeting configuration and execution templates are provided herein. In an example, the method may include receiving, from a first client device, a video conference template include one or more settings corresponding to a configuration of a virtual meeting, storing, by a video conference provider, the video conference template associated with the first client device, receiving, by the video conference provider, a request to establish a virtual meeting, and establishing, by the video conference provider, the virtual meeting based on the video conference template. The virtual meeting may include a plurality of participants, each participant of the plurality of participants exchanging one or more audio or video streams via the virtual meeting using a plurality of client devices.

### FIELD

The present application generally relates to video conferences and more particularly relates to systems and methods for providing virtual meeting configuration and execution templates.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1, 2, and 3 show example systems for providing virtual meeting configuration and execution templates, according to an embodiment herein;

FIG. 4 illustrates a calendar panel for creating an event template, according to an embodiment herein;

FIG. 5A illustrates a template setup prompt for creating an event template, according to an embodiment herein;

FIG. 5B illustrates an example event template, according to an embodiment herein;

FIG. 6 illustrates a graphical user interface (GUI) during a virtual meeting based on an example event template, according to an embodiment herein;

FIG. 7 illustrates a GUI during a webinar based on another example event template, according to an embodiment herein;

FIG. 8 illustrates a GUI during a virtual event based on another example event template, according to an embodiment herein;

FIG. 9 illustrates an example speech recognition system that may be locally or remotely executed, according to an embodiment herein;

FIG. 10 illustrates an example system for transcribing speech data that may be locally or remotely executed, according to an embodiment herein;

FIG. 11 illustrates an example method for providing virtual meeting configuration and execution templates, according to an embodiment herein; and

FIG. 12 shows an example computing device suitable for providing virtual meeting configuration and execution templates, according to this disclosure.

### DETAILED DESCRIPTION

Examples are described herein in the context of systems and methods for providing virtual meeting configuration and execution templates. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Video conference providers can enable people to interact with each other using their own computers (or “client devices”) with both video and audio in a variety of settings, such as in one-on-one conversations, group meetings, and webinars. While each of these types of settings can allow people to interact with each other, they can differ in character. For example, one-on-one conversations include only two people and may involve only a small amount of data being transmitted between the two client devices. Group meetings may involve a larger number of people all interacting with each other. In contrast, webinars typically involve a group of people that are attending to hear presentations from one or more presenters. Thus, in a webinar, interaction tends to be mostly one-way: from the presenter(s) to the audience. In addition, webinars can have very large numbers of participants, potentially numbering in the thousands or tens of thousands.

Over the past few years, the popularity of virtual meetings to replace conventional, in-person meetings, continues to rise. More and more interactions and events between people are moving into the virtual space. For example, city council meetings, concerts, educational lectures, workshops, baby showers, and even funerals are being hosted in the virtual space. As the variety and circumstances of virtual events continue to expand, so too does the breadth and technology level knowledge of people who are arranging and employ virtual meetings. In other words, as more events are moving into the virtual space, people who previously had little experience within the virtual space are now beginning to create and host virtual events. As used herein, a person who creates, and in some cases hosts, a virtual event is referred to as an event creator.

A common problem that is encountered during creating and hosting of virtual meetings is incorrect selection of various meeting settings. Specifically, a meeting setting may be incorrectly selected based on the event type. For example, a meeting setting for participants' audio stream sharing during a webinar may be incorrectly selected to allow all participants to exchange audio streams instead of being muted for attendees. As can be appreciated, allowing all participants to exchange audio streams during a webinar, instead of limiting audio stream exchange to only webinar panelists, can cause for disruption during the event. Similar issues can be caused by incorrect selection of other meeting settings. For example, if a speech recognition setting is not selected for a virtual event in which hearing impaired individuals are invited, this can negatively impact the user experience for the meeting participants.

To provide event creators with a quick and efficient way to create virtual events with appropriate meeting settings based on the event type, example virtual meeting configuration and execution templates are provided herein. Virtual meeting configuration and execution templates, referred to herein as event templates, can provide selection of various meeting settings based on the event type as well as input from an event creator. For example, an event creator that manages a band's virtual event calendar may generate an event template to be used for the band's public concerts. Since each of the public concerts will be hosted as a virtual event, having similar content (e.g., live-streaming of a concert), the event creator may generate an event template for these events. This can allow the event creator to create future virtual events using the same configuration and execution settings, thereby ensuring that the applicable and correct meeting settings are used for each event. Additionally, by using the same event template for the virtual event, the event creator can minimize time spent generating the event invitations for each virtual event.

As will be described in greater detail below, meeting settings for a virtual event may include a variety of settings relating to the configuration and execution of the virtual event. For example, meeting settings may include multimedia stream settings, speech recognition settings, participant settings, display settings, privacy settings, and the like. Multimedia stream settings may include settings for exchanging one or more video streams, audio streams, or chat messaging. For example, during a webinar, the multimedia stream settings may limit the exchange of audio streams for attendees but allow for exchange of audio streams of the webinar panelists. Speech recognition settings may include translation settings or transcription settings. For example, during a virtual event, transcription settings may provide live transcription of any audio streams exchanged during the event. Participant settings may include meeting invitation settings or participant interaction settings. For example, during a virtual meeting the participant interaction settings may allow some participants to share content or participate in polls, while limiting other participants' ability to perform such interactions. Display settings may include various settings relating to how video streams and virtual content is provided to viewing participants during a virtual event. And privacy settings may include recording settings or meeting encryption settings. For example, during a virtual meeting the recording settings may allow participants to record the meeting but limit the participants' ability to share the meeting recording with people outside of the meeting invitation list.

This illustrative example is given to introduce the reader to the general subject matter discussed herein and the disclosure is not limited to this example. The following sections describe various additional non-limiting examples and examples of systems and methods for providing virtual meeting configuration and execution templates.

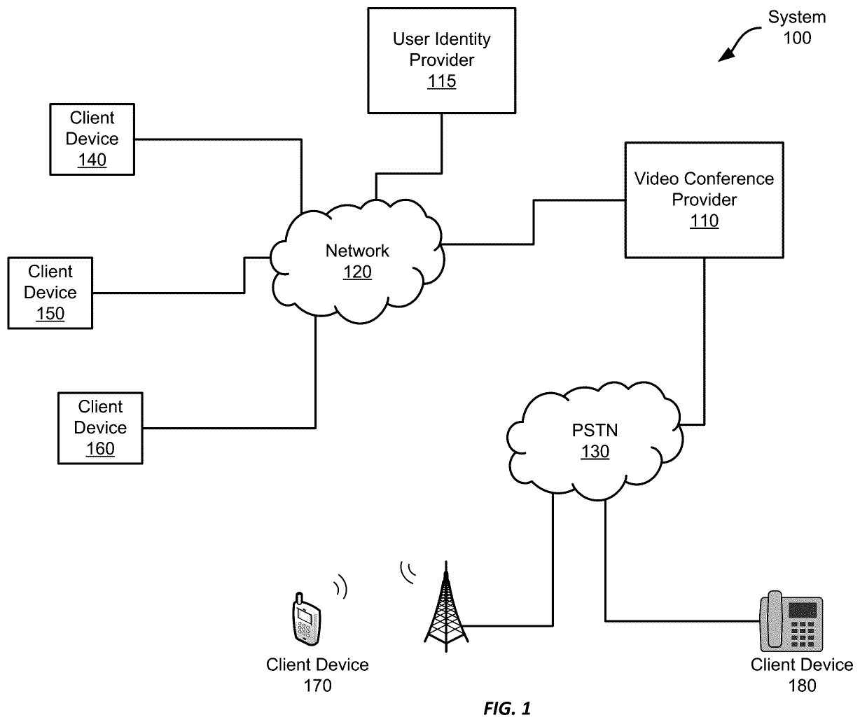

Referring now to FIG. 1, FIG. 1 shows an example system 100 that provides video conferencing functionality to various client devices. The system 100 includes a video conference provider 110 that is connected to multiple communication networks 120, 130, through which various client devices 140-180 can participate in video conferences hosted by the video conference provider 110. For example, the video conference provider 110 can be located within a private network to provide video conferencing services to devices within the private network, or it can be connected to a public network, e.g., the internet, so it may be accessed by anyone. Some examples may even provide a hybrid model in which a video conference provider 110 may supply components to enable a private organization to host private internal video conferences or to connect its system to the video conference provider 110 over a public network.

The system optionally also includes one or more user identity providers, e.g., user identity provider 115, which can provide user identity services to users of the client devices 140-160 and may authenticate user identities of one or more users to the video conference provider 110. In this example, the user identity provider 115 is operated by a different entity than the video conference provider 110, though in some examples, they may be the same entity.

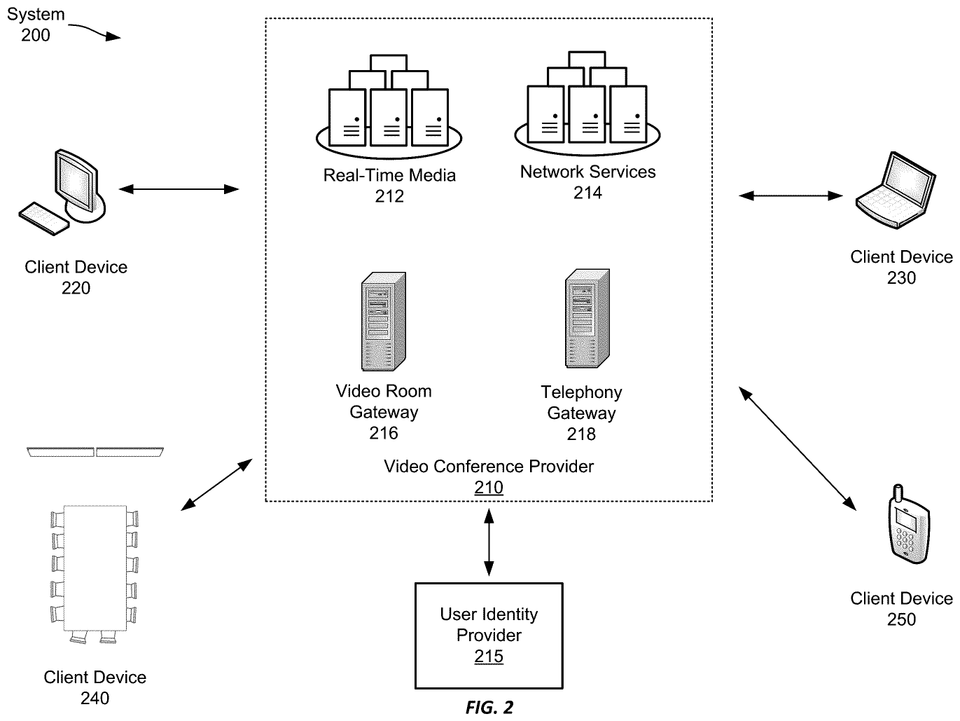

Video conference provider 110 allows clients to create video conference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the video conference provider 110. It should be understood that the term “meeting” encompasses the term “webinar” used herein.

Meetings in this example video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common video conference may be used.

To create a meeting with the video conference provider 110, a user may contact the video conference provider 110 using a client device 140-180 and select an option to create a new meeting. Such an option may be provided in a webpage accessed by a client device 140-160 or client application executed by a client device 140-160. For telephony devices, the user may be presented with an audio menu that they may navigate by pressing numeric buttons on their telephony device. To create the meeting, the video conference provider 110 may prompt the user for certain information, such as a date, time, and duration for the meeting, a number of participants, a type of encryption to use, whether the meeting is confidential or open to the public, etc. After receiving the various meeting settings, the video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started or the host may be required to specifically admit one or more of the users.

During the meeting, the participants may employ their client devices 140-180 to capture audio or video information and stream that information to the video conference provider 110. They also receive audio or video information from the video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The video conference provider 110 may also invalidate the meeting information, such as the meeting identifier or password/passcode.

To provide such functionality, one or more client devices 140-180 may communicate with the video conference provider 110 using one or more communication networks, such as network 120 or the public switched telephone network (“PSTN”) 130. The client devices 140-180 may be any suitable computing or communications device that have audio or video capability. For example, client devices 140-160 may be conventional computing devices, such as desktop or laptop computers having processors and computer-readable media, connected to the video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and is not limited solely to dedicated telephony devices like conventional telephones.

Referring again to client devices 140-160, these devices 140-160 contact the video conference provider 110 using network 120 and may provide information to the video conference provider 110 to access functionality provided by the video conference provider 110, such as access to create new meetings or join existing meetings. To do so, the client devices 140-160 may provide user identification information, meeting identifiers, meeting passwords or passcodes, etc. In examples that employ a user identity provider 115, a client device, e.g., client devices 140-160, may operate in conjunction with a user identity provider 115 to provide user identification information or other user information to the video conference provider 110.

A user identity provider 115 may be any entity trusted by the video conference provider 110 that can help identify a user to the video conference provider 110. For example, a trusted entity may be a server operated by a business or other organization and with whom the user has established their identity, such as an employer or trusted third-party. The user may sign into the user identity provider 115, such as by providing a username and password, to access their identity at the user identity provider 115. The identity, in this sense, is information established and maintained at the user identity provider 115 that can be used to identify a particular user, irrespective of the client device they may be using. An example of an identity may be an email account established at the user identity provider 115 by the user and secured by a password or additional security features, such as biometric authentication, two-factor authentication, etc. However, identities may be distinct from functionality such as email. For example, a health care provider may establish identities for its patients. And while such identities may have associated email accounts, the identity is distinct from those email accounts. Thus, a user's “identity” relates to a secure, verified set of information that is tied to a particular user and should be accessible only by that user. By accessing the identity, the associated user may then verify themselves to other computing devices or services, such as the video conference provider 110.

When the user accesses the video conference provider 110 using a client device, the video conference provider 110 communicates with the user identity provider 115 using information provided by the user to verify the user's identity. For example, the user may provide a username or cryptographic signature associated with a user identity provider 115. The user identity provider 115 then either confirms the user's identity or denies the request. Based on this response, the video conference provider 110 either provides or denies access to its services, respectively.

For telephony devices, e.g., client devices 170-180, the user may place a telephone call to the video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the video conference provider 110. For example, telephony devices may be unable to provide user identification information to identify the telephony device or the user to the video conference provider 110. Thus, the video conference provider 110 may provide more limited functionality to such telephony devices. For example, the user may be permitted to join a meeting after providing meeting information, e.g., a meeting identifier and passcode, but they may be identified only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide user identification information to the video conference provider 110, even in cases where the user has an authenticated identity and employs a client device capable of identifying the user to the video conference provider 110. The video conference provider 110 may determine whether to allow such anonymous users to use services provided by the video conference provider 110. Anonymous users, regardless of the reason for anonymity, may be restricted as discussed above with respect to users employing telephony devices, and in some cases may be prevented from accessing certain meetings or other services, or may be entirely prevented from accessing the video conference provider 110.

Referring again to video conference provider 110, in some examples, it may allow client devices 140-160 to encrypt their respective video and audio streams to help improve privacy in their meetings. Encryption may be provided between the client devices 140-160 and the video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the video conference provider 110, while allowing the video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a video conference provider 210 provides video conferencing functionality to various client devices 220-250. The client devices 220-250 include two conventional computing devices 220-230, dedicated equipment for a video conference room 240, and a telephony device 250. Each client device 220-250 communicates with the video conference provider 210 over a communications network, such as the internet for client devices 220-240 or the PSTN for client device 250, generally as described above with respect to FIG. 1. The video conference provider 210 is also in communication with one or more user identity providers 215, which can authenticate various users to the video conference provider 210 generally as described above with respect to FIG. 1.

In this example, the video conference provider 210 employs multiple different servers (or groups of servers) to provide different Examples of video conference functionality, thereby enabling the various client devices to create and participate in video conference meetings. The video conference provider 210 uses one or more real-time media servers 212, one or more network services servers 214, one or more video room gateways 216, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the video conference provider 210 may allow a meeting participant to notify it of inappropriate behavior or content in a meeting. Such a notification may trigger the real-time media servers to 212 record a portion of the meeting for review by the video conference provider 210. Still other functionality may be implemented to take actions based on the decrypted multimedia streams at the video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system 200 and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the video conference provider under a supervisory set of servers. When a client device 220-250 accesses the video conference provider 210, it will typically communicate with one or more network services servers 214 to access their account or to participate in a meeting.

When a client device 220-250 first contacts the video conference provider 210 in this example, it is routed to a network services server 214. The client device may then provide access credentials for a user, e.g., a username and password or single sign-on credentials, to gain authenticated access to the video conference provider 210. This process may involve the network services servers 214 contacting a user identity provider 215 to verify the provided credentials. Once the user's credentials have been accepted, the network services servers 214 may perform administrative functionality, like updating user account information, if the user has an identity with the video conference provider 210, or scheduling a new meeting, by interacting with the network services servers 214.

In some examples, users may access the video conference provider 210 anonymously. When communicating anonymously, a client device 220-250 may communicate with one or more network services servers 214 but only provide information to create or join a meeting, depending on what features the video conference provider allows for anonymous users. For example, an anonymous user may access the video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may identify the user and issue a command through a user interface on their client device. The command may be sent to a network services server 214, which may then disconnect the identified user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the video conference provider 210. For example, the video conferencing hardware may be provided by the video conference provider to one or more of its subscribers, which may provide access credentials to the video conferencing hardware to use to connect to the video conference provider 210.

The video room gateway servers 216 provide specialized authentication and communication with the dedicated video conferencing hardware that may not be available to other client devices 220-230, 250. For example, the video conferencing hardware may register with the video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the video conference provider 210.

Referring now to the telephony gateway servers 218, these servers 218 enable and facilitate telephony devices' participation in meetings hosted by the video conference provider 210. Because telephony devices communicate using the PSTN and not using computer networking protocols, such as TCP/IP, the telephony gateway servers 218 act as an interface that converts between the PSTN and the networking system used by the video conference provider 210.

For example, if a user uses a telephony device to connect to a meeting, they may dial a phone number corresponding to one of the video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio signals to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server 218 is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

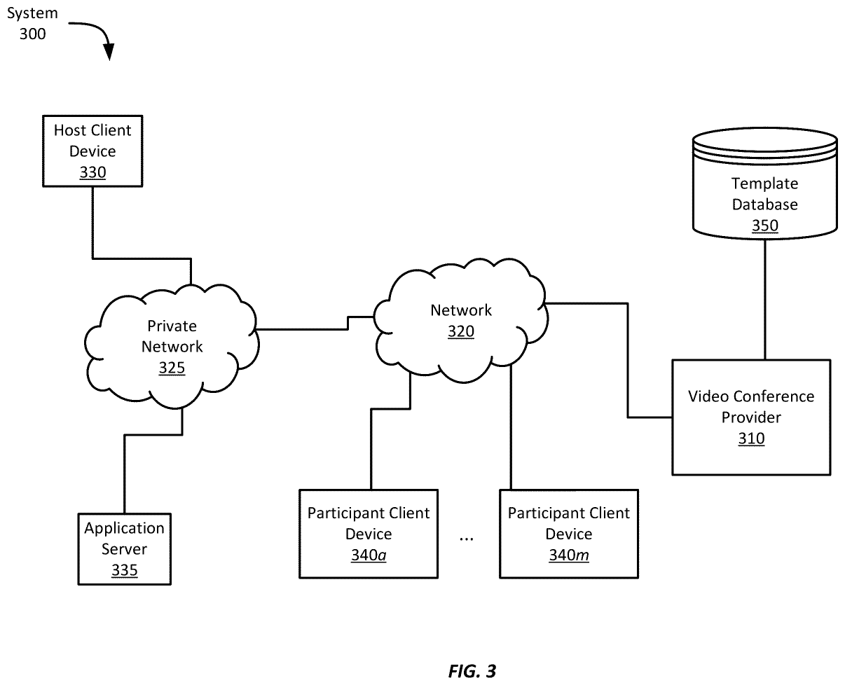

Referring now to FIG. 3, FIG. 3 shows an example system 300 for providing virtual meeting configuration and execution templates, according to an embodiment herein. As illustrated, a video conference provider 310 provides video conference services to multiple different client devices 330 and 340a-m, generally as described above with respect to FIGS. 1 and 2. In this example, the client devices 330 and 340a-m participate in a virtual meeting hosted by the video conference provider 310. Client devices 340a-m connect to the video conference provider 310 over a public network 320, e.g., the internet; however, host client device 330 participates from within a private network 325, such as from their office at work. In addition to the host client device 330, an application server 335 is connected to the private network and makes various business applications available to the host client device 330. In different examples, these business applications may vary; however, in this example, the application server 335 provides applications access to business databases and files. To access these various resources, the host client device 330 has different client applications installed on it and may also have web applications accessible via a web browser, which may be stored as bookmarks in the web browser.

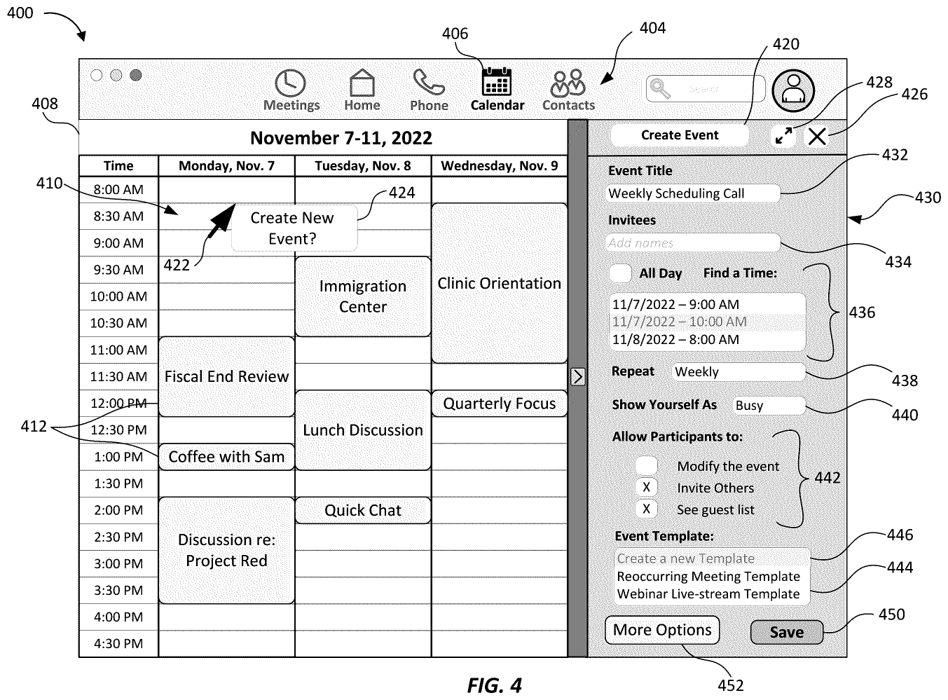

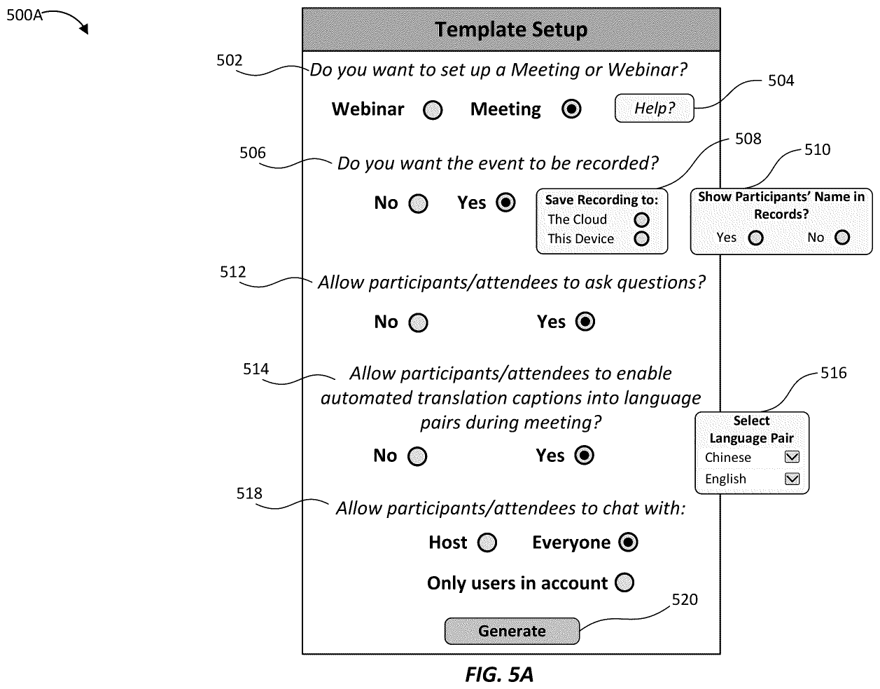

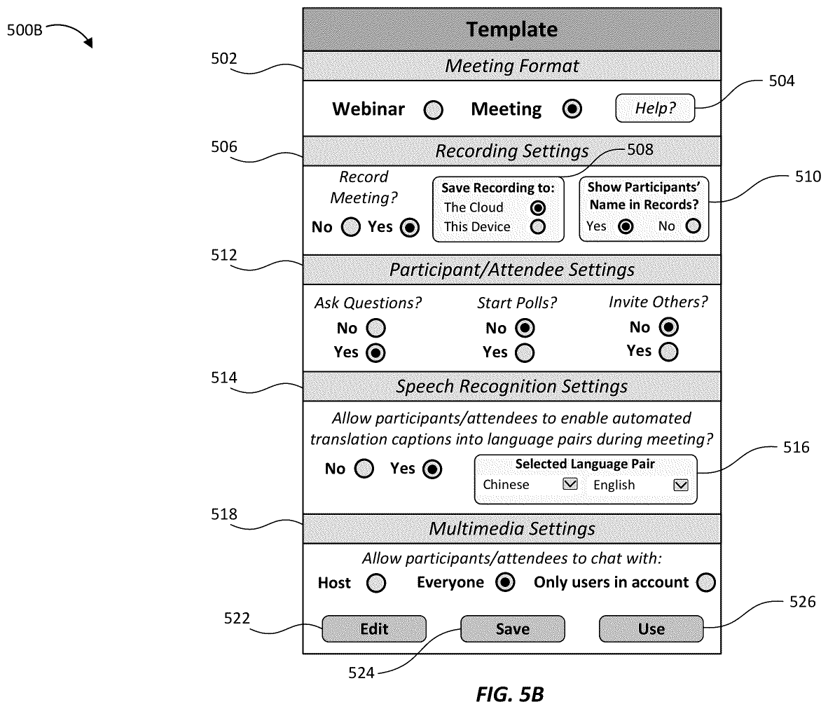

Prior to initiation of a virtual meeting, a meeting invitation may be generated and transmitting to participants on an invitation list. For example, the host client device 330 may generate a meeting invitation and request the video conference provider 310 to transmit the meeting invitation to client devices on an associated invitation list. As will be described in greater detail with respect to FIGS. 4 and 5, the client device 330 may first request to generate a meeting invitation. For example, the client device 330 may open a video conference application and select an option to ‘create a virtual meeting invitation.’ Upon selection of this option, the client device 330 may be prompted to select an event template. Event templates may include default or template settings for a variety of features (e.g., multimedia stream settings, speech recognition settings, participant settings, display settings, privacy settings) for configuration and execution of a virtual meeting. As noted above, the template for a virtual meeting may depend on the type or format of the virtual meeting being created and executed.

In response to the prompt to select an event template, the client device 330 may select a previously generated event template. If the client device 330 selects a previously generated event template, such as from a list of available event templates, then the client device 330 may transmit a request for the previously generated event template to the video conference provider 310. Responsive to the request, the video conference provider 310 may query a template database 350 for the requested event template. The template database 350 may be hosted by the video conference provider 310 or the template database 350 may be hosted by a third-party. In another embodiment, the template database 350 may be stored locally on the client device 330. In some cases, the client device 330 may not request the previously generated event template from the video conference provider 310 and instead query the template database 350 directly.

As will be described in greater detail below, in some embodiments the client device 330 may select an option to generate a new template that can be saved for future virtual meetings instead of requesting a previously generated event template. In such cases, the client device 330 may generate a meeting invitation, selecting the desired features for configuration and execution of the virtual meeting, and then request to save the new event template. To save the new event template, the client device 330 may transmit a request to save the new event template to the video conference provider 310, who in turn may save the new template to the template database 350. In cases where the template database 350 is hosted locally on the client device 330, the client device 330 may save the new template directly to the template database 350.

In response to the request for an event template, the client device 330 may receive the event template from the template database 350, such as from either via the video conference provider 310 or directly from the template database 350. Upon receipt of the event template, one or more features of the meeting invitation may be automatically populated based on the event template. As will be described in greater detail below, example features that may be auto-populated based on the event template may include a participant invitation list, a privacy setting for the meeting, and one or more multimedia stream settings for the virtual meeting. The client device 330 may review the auto-populated features of the meeting invitation, including the settings relating to the meeting configuration and execution, and change any desired features from the template settings. If the client device 330 does not want to change any of the selected settings, then the client device 330 can select the option to send the meeting invitation to client devices listed in the participant invitation list. For the following example, the participant invitation list may include at least the client devices 340a-340m, thus the meeting invitation may be transmitted to the client devices 340a-340m.

When the time for the meeting to start occurs, the virtual meeting may be started based on the settings of the meeting invitation, which may be stored in any suitable form, such as within the meeting invitation itself or in a configuration associated with the scheduled meeting at the virtual conference provider. In some examples, the template may be provided to the virtual conference when the meeting is started to establish the specified configurations for the meeting. To start a meeting, the host client device 330 connects to the video conference provider 310 and begins a virtual meeting (“meeting”) at the video conference provider 310, such as by beginning a scheduled meeting, generally as described above with respect to FIGS. 1 and 2. The video conference provider 310 may create and manage the meeting as discussed above.

Once the virtual meeting starts, each of the client devices 340a-340m and the host client devices 330 may be able to interact during the virtual meeting based on the settings established in the template. For example, if the virtual meeting is a webinar, then the client devices 340a-340m may be attendees and thus may not be able to exchange audio streams during the virtual meeting. In another example, if the virtual meeting is a video conference, then the client devices 340a-340m may be able to exchange one or more types of multimedia streams, such as video, audio, or chat messages, during the virtual meeting. Depending on the settings, participants may be able to interact with other participants and see their respective names, such as in close proximity to other participants' video streams or in a list of participants visible in a graphical user interface (“GUI”). In some embodiments, the participants may only be able to see information, e.g., names or video feeds, from the host(s) of the meeting or certain select participants that will be engaged in discussions during the virtual meeting, such as panelists in a panel discussion. Still other limits may be imposed on the various participants, such as their ability to react to occurrences during the meeting, e.g., participants may be allowed to interact with their GUI to raise their hand to ask a question but may not be allowed to provide any other feedback.

During the meeting one of the participant client devices 340a-m or the host client device 330 may request to record the meeting. Again, the ability to record and who has the ability to record may be determined by the meeting settings. If a client device, such as the client device 340a has the ability to record the virtual meeting, a request to record the meeting may be transmitted to the video conference provider 310. In some embodiments, the video conference provider 310 may prompt the non-requesting client devices with a notification that the meeting is going to be recorded. For example, if the host client device 330 request to record the meeting, the participant client devices 340a-m may receive a notification that the meeting is going to be recorded. Once the meeting request is accepted, the video conference provider 310 may record the audio and video streams from all of the client devices, 340a-m and 330, until the recording is terminated, or the meeting is ended. It should be appreciated that while the above discussion with respect to FIGS. 1-3 relates to virtual meetings or meetings, the systems and methods described also relate to other virtual event formats, such as webinars, virtual meetings, or virtual concerts.

Referring now to FIG. 4, an example calendar panel 400 for creating an event template is illustrated, according to an embodiment herein. In some embodiments, a meeting invitation may be generated from the calendar panel 400. In other embodiments, the meeting invitation may be generated via another means from a video conferencing application. While the following example is described with relation to the calendar panel 400, it should be appreciated that the following description may apply to cases where the meeting invitation is generated via other means from the video conferencing application.

The calendar panel 400 may provide access to a variety of calendaring or meeting scheduling functionalities, generating a new virtual event. The calendar panel 400 may also provide a view of a calendar 408, according to an embodiment herein. The calendar 408 may be accessible through the calendar panel 400 by selecting a respective calendar from available calendars. As could be appreciated, a user may have more than one calendar, such as a work calendar and a personal calendar. The calendar panel 400 may be displayed on a client device, such as the host client device 330, in response to information sent by a video conference provider, such as the chat and video conference provider 310 in FIG. 3. The calendar panel 400 may be generated by an application, e.g., a standalone calendar client or integrated into a video conferencing application, run by one or more processors stored on the client device.

The calendar panel 400 may include a general dashboard 404, a calendar 408, and an event creation panel 430. The general dashboard 304 may include one or more buttons or links that switch functionalities and/or views of the calendar panel 400. For example, FIG. 4 shows a calendar view, perhaps in response to a user command selecting the calendar button 406 in the general dashboard 404. In this view, the calendar 408 and other components illustrated in FIG. 4 may be displayed on the client device responsive to selection of the calendar button 406. In other examples, a contacts button may be selected by a user. In response the contacts button being selected, the calendar 408 may be replaced by a display of a contacts window including a list of user contacts associated with the user of the client device. It should be appreciated that other configurations are also possible. Various buttons on the general dashboard 404 may correspond to various displays of windows being displayed on the client device. Any number of components shown in FIG. 4 may be displayed on the client device with any of the various windows. Similarly, any of the components may cease to be displayed in accordance with any of the windows.

As illustrated, the calendar 408 may provide a chart of timeframes over a given time duration. For example, the calendar 408 provides time slots between 8 A.M. and 4:30 P.M. for the dates of Nov. 7-11, 2022. While only time slots for November 7-9 are displayed on the calendar 408, a user may be able to scroll over to view the time slots for November 10 and 11 via selection of button 402. It should be appreciated that the calendar 408 may display time slots for any time duration, such as for example, by days, weeks, months, or even years.

The calendar 408 may display events 412. The events 412 may include scheduled events or tentative events. In some embodiments, the events 412 may include virtual events or may be events that do not correspond to a virtual event, such as an in-person meeting, reminder, or any other type of event.

A user may schedule an event 412 directly from the calendar 408. To schedule a new event, the user may select a desired time slot, as illustrated, or may select anywhere on the calendar 408. For example, the user may right-click using a cursor 422 at a desired time slot and be prompted with an option 424 to create a new event. In some embodiments, the calendar 408 may include a create event option 420 from which a user can create a new event. Responsive to selection of the option 424 or the option 420, the event creation panel 430 may be displayed. Although the event creation panel 430 is illustrated as part of the calendar panel 400, it should be appreciated that the event creation panel 430 may be displayed as a separate window. In some embodiments, the user may select the pop-out option 428 to generate a separate window for the event creation panel 430. A separate window for the event creation panel 430 may allow a user to move the event creation panel 430 around as needed to view relevant content for creation of a meeting invitation. If a user wants to close the event creation panel 430, the user can select the close option 426.

The event creation panel 430 may provide various options for a virtual event being scheduled. For example, the event creation panel 430 may include an event title 432 into which a user can provide a title for the virtual event. The event creation panel 430 may also include an invitees option 424 into which a user can input participant's names to be included on a participant invitation list. For example, a user may input a participant's name, email address, or tag.

The event creation panel 430 may also include a scheduling option 436 into which the user can select a date and time for the virtual event. In some embodiments, the scheduling option 436 may auto-populate based on a time slot selected by the user at the invitation of the creation of the event. For example, as illustrated, because the cursor 422 is selecting the date and time of November 7 at 8:30 A.M., then the scheduling option 436 may auto-populate with November 7 at 8:30 A.M. for the virtual event. A user may change the date and time, but the auto-populated time may be used as a starting point. In other embodiments, the scheduling option 436 may auto-populate with a recommended time based on the schedules of participants added to the invitee option 424. For example, once a user inputs a participant's name into the invitee option 424, the video conference provider 310 may provide available time slots on that respective participant's calendar as available timeslots for a virtual event. The event creation panel 430 may then compare the available time slots for the participant to the available time slots on the calendar 408 and auto-populate with a recommended time slot when both parties are available.

The event creation panel 430 may also include a reoccurrence option 438. The reoccurrence option 438 may allow a user to generate a meeting invitation a first time for generation of more than one meeting. For example, if the user desires to schedule a weekly meeting, then the user may only need to create a single meeting invitation for a virtual event that would occur weekly. Using the reoccurrence option 438, the user can select the frequency at which a virtual event can occur, such as daily, weekly, bi-weekly, monthly, quarterly, or annually.

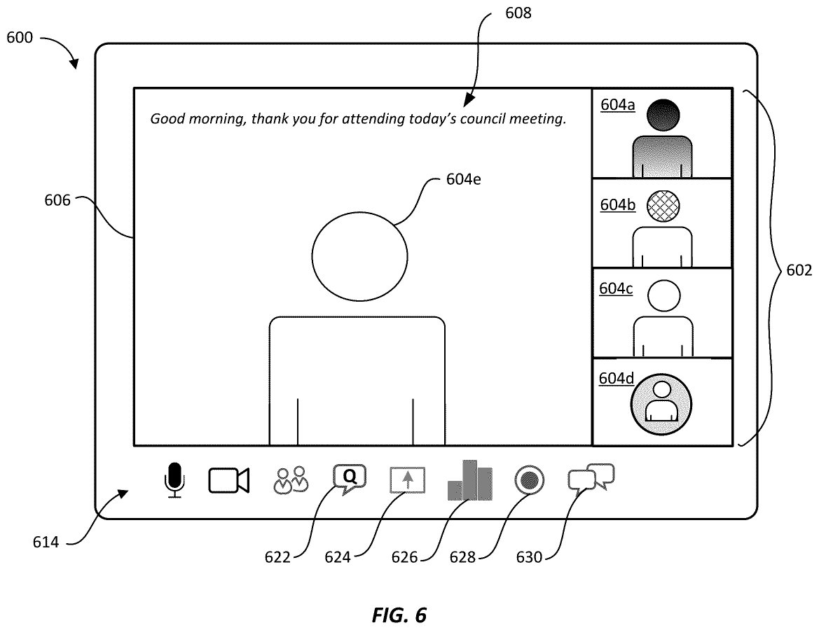

In some embodiments, the event creation panel 430 may include one or more participant settings. Participant settings may correspond to settings relating to a participant's interaction ability with the meeting invitation or with other participants. For example, the event creation panel 430 may include a status option 440. The status option 440 would update a participant's status during the virtual event. For example, a participant's status could be available, busy, in a meeting, or do not disturb during the virtual event. Another example of a participant setting is an invitation sharing setting 442. As illustrated, the invitation sharing setting 442 may allow a participant who is invited to a virtual event to modify the virtual event, (e.g., change the timeslot for the virtual event), invite other participants to the virtual event, or see a guest or participant list for the virtual event. Additional participant settings that will be discussed in greater detail with respect to FIGS. 5 and 6 include the ability of participants to interact with each other during a virtual event, such as by asking questions, participating in a poll, and the like.

Instead of or in addition to manually filling in the above-described options for creating a meeting, the user may select to use a previously prepared event template 444. Previously prepared event templates 444 may be previously generated by the user, by another user associated with the video conferencing application, or by the video conference provider 310. In an illustrative example, a previously prepared event template 444 may be a default template provided by the video conference provider 310. In such cases, an account setting associated with the default template may allow various settings of the previously prepared event template 444 to be modified by users. As described above with respect to FIG. 3, if the user selects a previously prepared event template 444, the template database 350 may be queried and a respective event template 444 may be provided to the user's client device. Upon receipt of the event template 444, the event creation panel 430 may be auto-populated with the one or more meeting settings provided by the event template 444.

In some embodiments, the user may wish to generate a new event template. To do so, the user may select the ‘Create a new Template’ option 446. Responsive to selection of the option 446, the user may be prompted to provide additional information regarding the meeting settings for the virtual event. For example, the user may be provided with a prompt, such as prompt 500A illustrated and discussed with respect to FIG. 5. Similarly, if the user selects the event template 444, the user may also be provided with the prompt 500A to review the auto-populated meeting settings based on the event template 444.

To view more options for scheduling a virtual event, the user may select more options 452. Upon selection 452, the user may be provided with additional meeting settings for the upcoming virtual event. When all of the features or settings are selected by the user, the user may select the save option 450. The save option 450 may save the created event and, in some embodiments, send the meeting invitation to participants listed in the invitee option 434.

Referring now to FIG. 5A, an example template setup prompt 500A for creating an event template is illustrated, according to an embodiment herein. As noted above, the prompt 500A may be displayed to a user in response to selection of the ‘Create a new Template’ option 446. While the following discussion follows this example, it should be appreciated that the prompt 500A may be provided to a user in response to other situations, such as responsive to the user's selection to use the event template 444. In such a situation, providing the prompt 500A may allow the user to review the meeting settings provided by the event template 444.

The prompt 500A may include various meeting settings. In some embodiments, the meeting settings provided by prompt 500A may auto-populate based on a format 502 of the virtual event. For example, as illustrated, the format 502 may provide options for the format of the virtual event being scheduled. Example formats may include a virtual meeting, a webinar, a virtual concert, a virtual live-streaming event, and the like. If a user is unsure which format 502 would provide the desired meeting settings, the user can select a help option 504. Upon selection of the help option 504, the user may be provided with a description of each type of meeting format, including what meeting settings may be provided or selected for each format type.

As noted above, meeting settings may include one or more of multimedia stream settings, speech recognition settings, participant settings, display settings, and privacy settings. Recording settings 506 may be an example of a privacy setting. For example, as illustrated, the recording settings 506 may indicate the user's selection for whether the virtual event is recorded or not. As can be appreciated, in some embodiments, a user may wish to record a virtual event, like a virtual concert, automatically. Thus, the user may select to record the event via the recording settings 506. Upon selection of an indication to record the event, additional recording setting options 508 and 510 may be provided. For example, the option 508 may provide options for where the event recording should be saved after the virtual event terminates or the recording completes. The option 510 may include additional options relating to privacy and the recording, such as should participants' names be provided in the recording. Additional options relating to the recording and privacy may be provided as part of the recording settings. For example, a recording setting may include settings for sharing of the recording, such as allowing participants to share the recording with people who did not attend the virtual event or restricting a duration of time during which the recording can be shared.

The meeting settings may also include one or more participant settings 512. As noted above, the participant settings 512 may include meeting invitation settings or participant interaction settings. For example, during a virtual meeting the participant interaction settings may allow some participants to share content or participant in polls, while limiting other participants' ability to perform such interactions. For example, the participant settings 512 of the illustrated example, provide a setting as to whether participants can ask questions during the virtual event. It can be appreciated that during a virtual concert, it may be undesirable for participants (e.g., attendees) to ask questions as it may be disruptive to the event. Other participant settings 512 may include whether a participant can participate in a poll or share content during the virtual event, such as his or her screen or a document. In some embodiments, the participant settings 512 may include one or more meeting invitation settings, as discussed above with respect to FIG. 4, or may include one or more encryption settings. The meeting invitation settings may include settings relating to the meeting invitation, such as whether participants can view a guest list, whether participants can share the meeting invitation, or who the meeting invitation can be shared with, such as participants can only be invited if they have a “.edu” email address. The encryption settings may include settings as to whether the virtual meeting is encrypted or whether participants require a password to join the virtual event.

The meeting settings may also include one or more speech recognition settings 514. Speech recognition settings may include translation settings or transcription settings. For example, as provided in the illustrated example, the speech recognition settings 514 may include a setting for whether participants can enable automated translation captions during the virtual event. As shown, if a participant selects to enable automated translation captions during the virtual event, options 516 for the language pairs for the automated translation captions may be provided. As can be appreciated, the options 516 may include other settings for enabling the automated translation captions. Other example speech recognition settings 514 may include transcription settings such as settings for whether participants can request a live transcription of any audio streams exchanged during the event or can request a transcription of the virtual event after termination of the event.

The meeting settings may also include one or more multimedia settings 518. The multimedia settings 518 may include settings for exchanging one or more video streams, audio streams, or chat messaging. For example, during a webinar, the multimedia stream settings may limit the exchange of audio streams for attendees but allow for exchange of audio streams of the webinar panelists. In the illustrated example, the multimedia settings 518 may include a setting as to whether participants can exchange chat messages, including who participants can exchange chat messages with. Additionally, multimedia settings 518 may include which participants can exchange audio streams or video streams, and with who participants can exchange audio streams or video streams. For example, during a virtual concert, only a performing participant may be allowed to transmit audio and video streams, while attendee participants may be prohibited from exchanging audio and video streams.

The meeting settings may also include other settings relating to the configuration and execution of a virtual event. For example, the meeting settings may include one or more display settings. Display settings may include various settings relating to how video streams and virtual content is provided to viewing participants during a virtual event. Display settings are discussed in greater detail with respect to FIGS. 6-8.

Once the user selects the desired meeting settings, the user can select the generate option 520. Upon selection of the generate option 520, an event template may be generated based on the selected meeting settings. In some embodiments, upon selection of option 520, the user may be provided with a preview of the template showing all of the meeting settings that have been selected or unselected. The preview can allow the user (e.g., template creator) to quickly review the configuration and meeting settings before saving the template.

In some embodiments, upon selection of the option 520, the event template is transmitted to the video conference provider 310, which in turn saves the event template. For example, the video conference provider 310 may save the event template to the template database 350. In other embodiments, upon selection of the generate option 520, the event template may be saved to client device associated with the user, such as for example, a local template database 350.

A user may be able to share a template that he or she generates with other users. For example, a user may generate an event template for a virtual concert for his or her company and share the event template with other members of the company. This way, all virtual concerts hosted by the company can conform to the same meeting settings. In some embodiments, a participant may like the configuration and execution of a virtual event and request the respective event template from the hosting participant. In such case, responsive to the request, the hosting participant can share the event template with the requesting participant. In some embodiments, the ability of an event template to be shared or the restriction of sharing of an event template may be determined by the generating user. For example, the prompt 500A may include a sharing option (not shown) in which the user can select whether the event template can be shared with other users or if other users are prohibited from using the event template or need to ask for permission to use the event template.

Referring now to FIG. 5B, an example event template 500B is provided, according to an embodiment herein. For example, the event template 500B may be a template generated based on the selections provided in the prompt 500A. The event template 500B may be saved by the video conference provider 310 to the template database 350. In some embodiments, the event template 500B may be the same or similar to a preview provided to the event creator upon selection of the option 520.

As illustrated, the event template 500B may provide a user with a view of the various options that are selected for the template. For example, the event template 500B provides the various setting selected for the meeting format 502, the recording settings 506, the participant settings 512, the speech recognition settings 514, and the multimedia settings 518. The event template 500B also provides the selection for subsettings, such as the recording subsettings 508 and 510 and options 516 for the automated translation captions.

Unlike conventional approaches to creating a meeting, the event template 500B provides a user the ability to view all the options selected for the meeting settings. This can allow a user to see what options are set for the event template 500B. If a user wants to change one or more of the setting selections, the user can select the edit button 522. Upon selection of the edit button 522, the user may be able to change one or more of the meeting settings. For example, if the event template 500B is selected by the user when creating a meeting and the user likes all the settings except needs to change the selected language pair via option 516, the user can change the selected language pair on option 516 to the desired languages. If desired, the user can save the event template 500B with the changes as a new template. To do so, the user can select the save button 524. Upon selection of the save button 524, a new template may be generated and saved by the video conference provider 310.

If the user reviews and agrees with the setting selections of the event template 500B, the use can select the user button 526. Once a user selects an event template, such as the event template 500B, to use for a virtual event, the virtual event may be configured and executed based on the meeting settings of the event template, except for those settings that a user changes from the default event template settings. Turning now to FIGS. 6-8, example virtual events executed based on different event templates are provided and described in turn.

Referring now to FIG. 6, a GUI 600 during a virtual meeting based on an example event template is provided, according to an embodiment herein. For example, the GUI 600 may be provided by any client device, such as the client devices 330, and may be based on an event template generated in response to the selection of the generate option 520, as described above. The GUI 600 may be for a virtual event that has a virtual meeting format. As such, the meeting settings used to execute and display the GUI 600 may be based on the virtual meeting format.

As shown, the GUI 600 may include a display 606. The display 606 may include a roster 602 of video streams received from client devices joined to the virtual meeting. For example, the roster 602 may include video streams of participants 604a-604e received from the client devices 340a-340e during a virtual meeting hosted by the video conference provider 310. In some embodiments, the roster may include a video stream of some or all of the participants of the virtual meeting. In other embodiments, the roster 602 may include a picture, image, representation, avatar, or a listing of some or all of the participants who have joined the virtual meeting. When a participant joins the virtual meeting, the joining participant is added to the roster 602.

The roster 602 may be provided on the display 606 responsive to one or more meeting settings. For example, the inclusion of the roster 602 may be based on a display setting for whether a roster should be included in the GUI 600 and the video streams provided on the roster 602 may be based on a multimedia setting for whether participants can exchange video streams during the virtual event. Additional meeting settings that may relate to the roster 602 may include a privacy setting as to whether participants' name or information should be displayed on the roster 602 or whether a participant can attend the meeting anonymously.

Once a virtual meeting is initiated, video and audio streams may be exchanged between the participants, including the client devices 340a-340e. The display 606 may include the video stream of a currently speaking participant 604e, which may be a host of the virtual meeting corresponding to the host client device 330. The audio stream from participant 604e may also be transmitted along with the display 606. In some embodiments, more than one participant may be speaking, and in such cases, display 606 may include two or more windows providing the video streams from the speaking participants. Again, the ability of a participant to exchange audio or video streams during the virtual meeting may be based on the multimedia settings of the event template.

The display 606 may include a dashboard 614 containing one or more action selections. The actions provided on the dashboard 614 may be based on one or more meeting settings. For example, the dashboard 614 may include a recording selection 628 that allows a participant to record the streams of audio and video during the virtual meeting. If the recording settings, which can be part of the privacy settings, allows a participant to record the meeting, then the dashboard 614 may include the recording selection 628. If the recording settings, however, do not allow a participant to record the meeting, then the dashboard 614 may not include the recording selection 628 or the recording selection 628 may greyed out or otherwise unavailable. In some embodiments, a virtual meeting may automatically be recorded upon initiation of the virtual meeting, while in other embodiments, recording of the virtual meeting may only be in response to selection of the recording selection 628. Again, such actions may be determined by the recording settings of the event template.

The dashboard 614 may include other selections such as a chat selection 630, a polling selection 626, a sharing selection 624, and a Question selection 622. Similar to the recording selection 628, the inclusion or availability (e.g., greyed out if unavailable to a participant) of the selections 622, 624, 626, and 630 may be determined by the meeting settings of the event template for the virtual meeting. The availability and functionality of the chat selection 630 may be based on the multimedia settings which may determine whether a participant can exchange chat messages during the virtual meeting and, in some cases, determine with whom the participant can exchange chat messages with.

The availability and the functionality of the Question selection 622, the sharing selection 624, and the polling selection 626 may be determined by the participant settings. For example, the Question selection 622 may be based on whether a participant can ask questions during the virtual meeting. In some embodiments, a time during which a participant can ask questions may also be determined. For example, a participant can only ask questions during a question and answer (Q&A) segment of the virtual meeting, and thus the Question selection 622 is only available or functional, during the Q&A segment of the virtual meeting. The sharing selection 624 may be based on whether a participant can share content during the virtual meeting. In some embodiments, beyond whether the participant can share content, the participant setting may determine what type of content the participant can share. For example, a participant may be allowed to share his or her screen during the virtual meeting, but the participant cannot share pictures or other types of documents during the meeting. The polling selection 626 may be based on whether a participant can participant in polls during the virtual meeting. In some embodiments, the participant settings may also include whether a participant has the ability to generate a new poll to share during the virtual meeting.

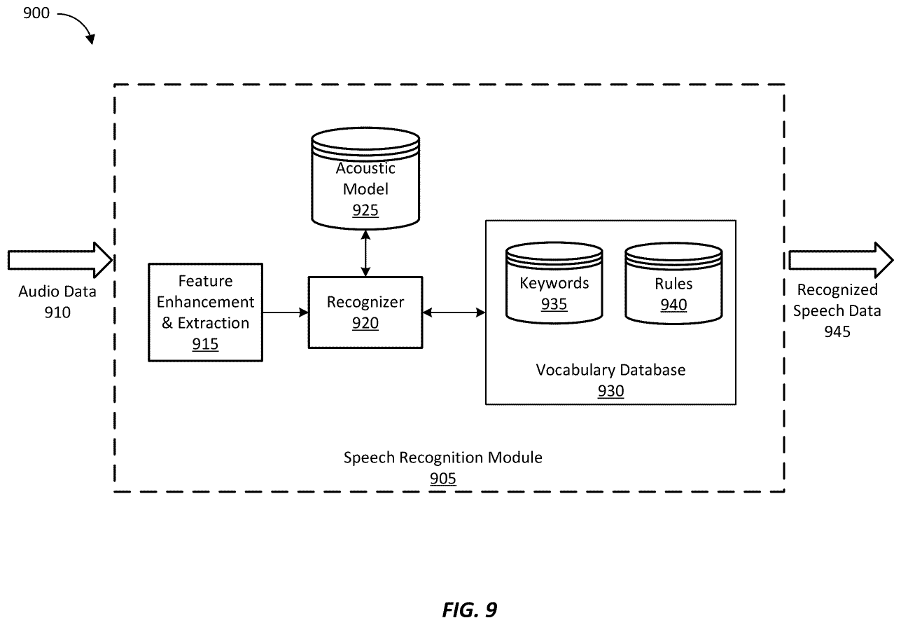

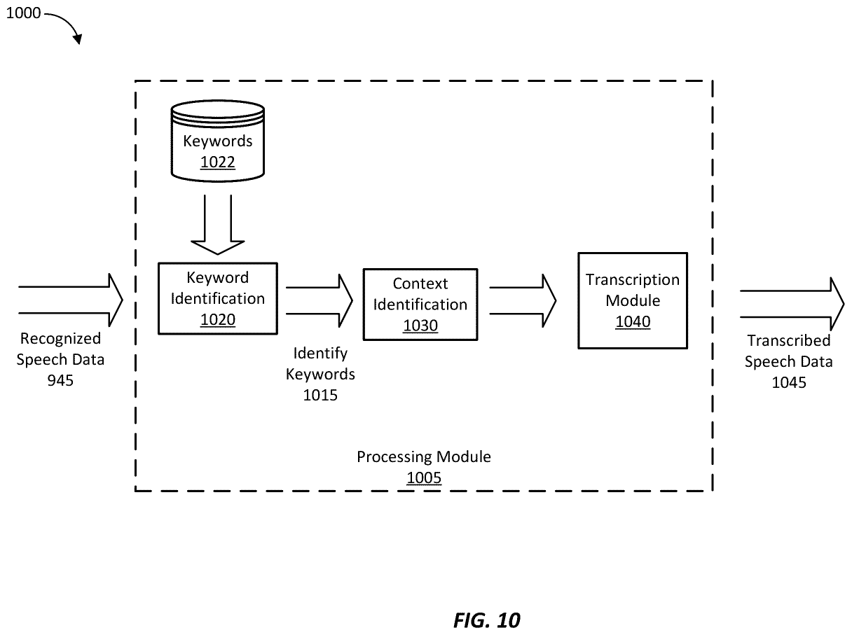

The display 606 may also include a transcription 608. The transcription 608 may be a live transcription of any audio streams exchanged during the virtual meeting. For example, the transcription 608 may be of the audio stream associated with the speaking participant 604e. The inclusion or display of the transcription 608 may be based on the speech recognition settings of the event template. The speech recognition settings may relate to any transcription or translation settings for the virtual event. For example, the speech recognition settings may determine whether a participant can request live transcription during the virtual event, such as by providing the transcription 608, or whether a participant can request a transcription of the virtual event after termination of the virtual event. In some embodiments, the speech recognition settings may determine whether a participant can request automated translation captions to provide captions in a second language if the audio streams are in a first language. For example, if the speaking participant 604e is speaking Spanish, and the automated translation captions are enabled for a Spanish to English translation, then the transcription 608 may instead provide an English translation of the speaking participant's 604e audio stream. Systems and methods for providing speech recognition functionality are described in greater detail below with respect to FIGS. 9 and 10.

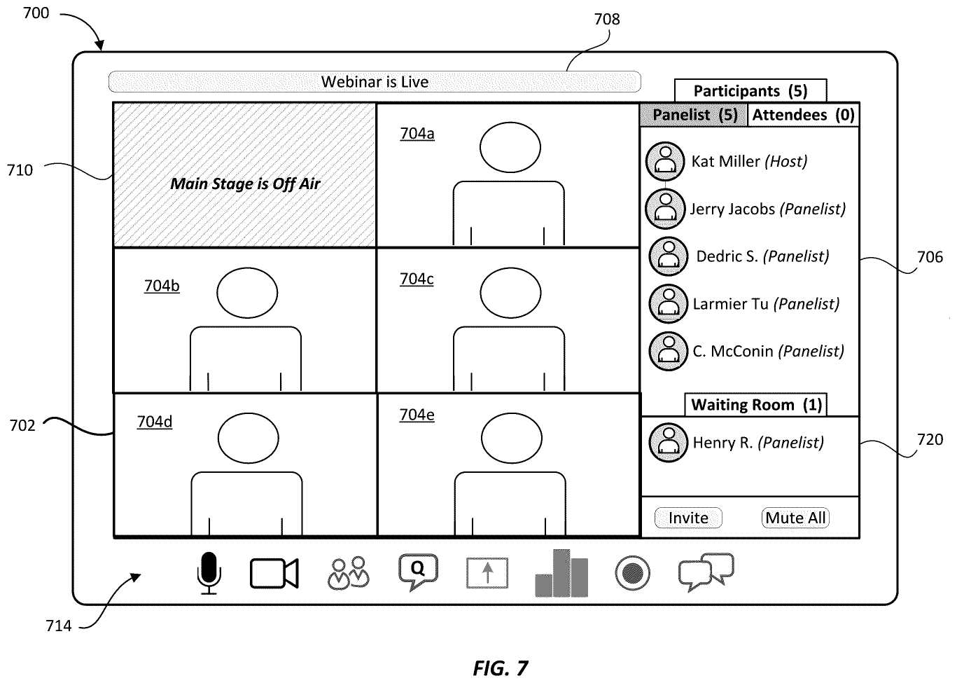

Referring now to FIG. 7, a GUI 700 for a webinar based on another example event template is illustrated, according to an embodiment herein. For example, the GUI 700 may be provided by any client device, such as the client devices 330, and may be based on an event template generated in response to the selection of the generate option 520, as described above. The GUI 700 may be for a virtual event that has a webinar format. As such, the meeting settings used to execute and display the GUI 700 may be based on the webinar format.

The GUI 700 may be viewable to a participant of a webinar, such as the participant corresponding to client device 340a. Presentation of the GUI 700 on the participant's client device may be in response to initiation of the webinar. The GUI 700 may include a display 706 which provides video and audio streams from other participants of the webinar. For example, the GUI 700 may display the video streams, and the respective audio streams may be also provided, from the other participants 704a-704e in the backstage 350. Participants 704a-704e may be hosts, panelists, or other participants/attendees of the webinar. The display of the video streams or transmission of audio streams from the participants 704a-704e may be determined by the multimedia settings for the event template used to generate the webinar.

The GUI 700 may include participant status indicator 708. Participant status indicator 708 may indicate to the participants a status of the webinar. For example, the indicator 708 may indicate the status of the webinar event and/or the “location” of the participant within the webinar event (e.g., in the mainstage or at a sidestage). The status indicator 708 may be helpful for a participant who transfers back and forth between different stages (e.g., different virtual rooms) during the webinar. The status indicator 708 may orient the participant as to which stage a given panelist is streaming from. The inclusion and display of the status indicator 708 may be based on the meeting settings of the event template, such as for example, as part of the display settings. As noted above, the display settings may relate to what information and content is provided to a participant of a virtual event, such as the information provided on the GUI 700.

The GUI 700 may include a participant list or roster 702 that displays information relating to the participants of the webinar. For example, the participant list 702 may display the name and/or image of the participants 704a-704e. In some embodiments, the participant list 702 may include a picture, image, representation, or a listening of participants. In some embodiments, the participant's role in the webinar may also be displayed next to the participant's name. The participant list 702 may include separate tabs/views depending on a participant's role in the webinar. For example, the participant list 702 may include a listing of the panelists, a listing of attendees, and a listing of participants in a waiting room. The participant list 702 may include a participant count for each of the different types of participants. Similar to the roster 602, inclusion of the roster 702, and the information provided therein, may be based on the meeting settings of the event template for the webinar.

The GUI 700 may also include a dashboard 714 that contains one or more action selections. The dashboard 714 may include one or more of the selections as described with respect to the dashboard 614. For example, the dashboard 714 can include a recording selection that allows a participant to record the streams of audio and video during the webinar. Similar to the dashboard 614, the inclusion and functionality of selections provided by the dashboard 714 may be determined by the meeting settings of the event template.

In some embodiments, a webinar may go live before the panelists or presenters are ready. As such, the display 706 may include an “off air” notification 710 for a corresponding feed from the panelists. The display of the notification 710 or the ability to start the webinar before the panelists are ready may be based on the meeting settings. For example, the notification 710 be based on a display setting while the ability to start the webinar before the panelists are ready may be based on a multimedia setting (e.g., the ability of participants to exchange multimedia streams before the panelists begin exchanging multimedia streams.)

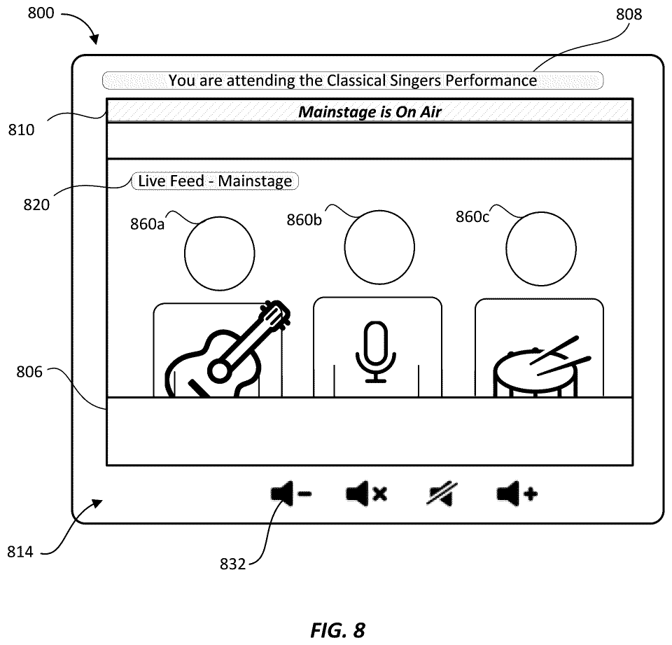

Referring now to FIG. 8, a GUI 800 for a virtual concert based on another example event template is illustrated, according to an embodiment herein. For example, the GUI 800 may be provided by any client device, such as the client devices 330, and may be based on an event template generated in response to the selection of the generate option 520, as described above. The GUI 800 may be for a virtual event that has a virtual concert format. As such, the meeting settings used to execute and display the GUI 800 may be based on the virtual concert format.

The GUI 800 may be viewable to a participant or attendee of the virtual concert, such as the participant corresponding to client device 340a. Presentation of the GUI 800 on the participant's client device may be in response to initiation of the virtual concert. The GUI 800 may include a display 806 which provides video and audio streams from the performers 860a, 860b, and 860c. For example, the display 806 may provide a video stream of a stage from which the performers 860a-c are performing, and the corresponding audio stream(s) may be transmitted to participants/attendees of the virtual concert. The display of the video streams or transmission of audio streams from the performers 860a-c may be determined by the multimedia settings for the event template used to generate the webinar.

As illustrated, the GUI 800 may have a dashboard 814 that only includes sound icons 832. That may be because the meeting settings do not allow for participants to interact during the virtual concert, as indicated by the participant settings, do not allow for participants to record the virtual concert, as indicated by the recording settings, and do not allow participants to exchange chat messages, as indicated by the multimedia settings. Instead, the display settings may provide for the display of volume settings for adjusting the audio streams during the virtual concert.

In addition to having minimal selections on the dashboard 814, the display 806 may also not provide a roster of participants/attendees. As can be appreciated, during a virtual concert there may be dozens, if not hundreds, of attendees and providing a roster may be of little value to other participants. As such, the meeting settings may determine to not provide a roster on the display 806. In some embodiments, the inclusion of the roster may be part of the privacy settings, multimedia settings, or the display settings, depending on the configuration of the meeting settings.

The display 806 may provide one or more notifications to orient a concert attendee. For example, the display 806 may include a notification 808 that describes what event the attendee is viewing. As illustrated, the notification 808 may provide descriptive information about which act or performance is being viewed. The display 806 may also provide a notification 810. The notification 810 may be provided when there is more than one “stage” or performance that an attendee can view during a virtual concert. Different “stages” may be hosted in different virtual rooms that attendees can join to view a performance. In cases where is only one “stage,” then the notification 810 may not be provided or may provide other information.

The display 806 may also provide notification 820 regarding the streaming status of the performance. As illustrated, the notification 820 may indicate that the viewing performance from the performers 860a-c is a live-streaming event. As can be appreciated, some virtual concerts are a mix of live and pre-recorded performances or acts, and as such, the notification 820 can let attendees know which type of multimedia streams they are receiving from the performers.

Turning now to FIG. 9, an example speech recognition system 900 that may be used to provide speech recognition functions is provided. The speech recognition system 900 may be executed locally or remotely. For example, the speech recognition system 900 may be locally executed on a client device, however, in other embodiments, the speech recognition system 900 may be cloud-based and/or remotely executed by a video conference provider, such as the video conference provider 310, or a third-party system.

The speech recognition system 900, along with the system 1000 described in greater detail with respect to FIG. 10, may be used to perform one or more of the functions described herein. In some embodiments, the speech recognition system 900 may be used to generate transcriptions of audio streams during or after a virtual meeting. In some cases, the transcription may be then used to provide translation, such as providing automated translation captions during a virtual meeting.

To perform speech recognition, the speech recognition system 900 may include a speech recognition module 905. The speech recognition module 905 may receive audio data 910. The audio data 910 may correspond to audio captured by a respective device capturing a multimedia stream, for example by a microphone. In other embodiments, the audio data 910 may be received from the video conference provider 310. The audio data 910 may be a recording of an audio track or may be a transcript of the audio track. The speech recognition module 905 may be or include a speech recognition system or model as known in the art. The following is an example speech recognition module following an example speech recognition process; however, it should be understood that other speech recognition modules or processes may be used.

Once the audio data 910 is received by the speech recognition module 905, the audio data 910 may be processed by a feature enhancement and extraction module 915. The feature enhancement and extraction module 915 may analyze the audio data for features corresponding to words and then enhance and extract any identified features. The identified features may correspond to audio waveforms present in human speech.

The speech recognition module 905 may also include a recognizer 920. The recognizer 920 may receive the identified features from the audio data 910. The recognizer 920 may employ an acoustic model 925 and a vocabulary database 930 to determine or associate the identified features in the audio data 910 to one or more words.

In an example embodiment, the acoustic model 925 may analyze the raw audio waveforms in the identified features and determine a corresponding phoneme for each waveform. In some embodiments, this is performed at the character or subword level. The vocabulary database 930 may be a language model. The vocabulary database 930 may include a rules database 940 and a word database 935. The rules database 940 may provide various rules for speech, allowing the recognizer to discard any association of identified features (e.g., audio waveforms) to phonemes that are improbable given the constraints of proper grammar and the topic of discussion. Once an appropriate mapping of the identified features to phonemes is generated, the recognizer 920 may determine words associated with the phonemes. The words may be based on the words database 935.

Once the phonemes are associated with respective words, recognized speech data 945 is generated. It should be understood that this process may be performed nearly instantaneously. For example, the speech recognition module 905 may generate the recognized speech data 945 during the meeting as the audio streams associated with the shared multimedia streams are being received by the video conference provider 310 or another system that is hosting the speech recognition system 900. The recognized speech 945 may be then used to perform one or more functions, such the dynamic prominence functionality.

Turning now to FIG. 10, an example system 1000 is provided. The system 1000 may perform one or more of the translation or transcription functions, as described herein. Specifically, the system 1000 may include processing module 1005 that is used to perform one or more of the translation or transcription functions described herein. For example, in one case, the recognized speech 945 may be received from the speech recognition system 1000 to identify correct keywords based on context within the recognized speech 945 and provide a transcription of the recognized speech 945.

The recognized speech 945 may be received by the keyword identification system 1020. The keyword identification system 1020 may identify one or more keywords in the recognized speech data 1045. The database of known keywords 1022 may be queried to identify any keywords in the track of recognized speech data 1045. Keywords in the keyword database 1022 may be based on keywords associated with common events. For example, keywords may include words like “Welcome,” “Let's get started, “Hello Everyone,” and the like. In some embodiments, keywords may include one or more emotion expressions, such as laughing or crying.

It should be understood that a keyword may include more than one word. For example, “Let's get started” may be a “keyword” as indicating that a speaker is beginning a presentation. Depending on various implementations, multi-word keywords may be treated as a single keyword or as multiple associated keywords. Further, a keyword may have multiple different forms. For example, a keyword may be a verb, which may be spelled different depending on context, e.g., it is conjugated differently depending on tense, subject, etc. Thus, a keyword may include variants of a base word, e.g., “look,” “looks,” and “looking.” In some examples each of these may be a distinct keyword, while in other examples, the variants may be associated with a base term, e.g., “look,” that is used as the keyword. However, any suitable approach to recognizing keywords may be used.

In some embodiments, a keyword may include or be an audio signature or audio activity. For example, a keyword may include screaming, loud noises, or other distinct audios sounds that are known to correspond with communication (e.g., laughter). In other embodiments, a keyword may include or be an accent or other vocal feature, such as a lisp.

If one or more keywords 1015 is recognized, the processing module 1005 then may identify a context 1030 associated with the keyword 1015. In this example, to identify a context, the processing module 1005 may employ a trained machine learning (“ML”) technique to semantically analyze the speech or transcript associated with the identified keyword 1015 to determine additional related keywords and/or descriptors. To perform the analysis, the trained ML technique may be provided the keyword(s) and a predetermined number of words near the keyword, e.g., preceding and following the keyword(s), such as five to ten words preceding and following the keyword(s). Words such as articles (e.g., “a”, “the”) or prepositions such as “of” or “for” may be omitted from the word count in some examples.

Since people may use jargon or colloquial terms to refer to particular actions, the context identification 1030 functionality may normalize recognized words to specific meanings. For example, the terms “kids,” “offspring,” “kiddos,” “little ones,” etc. all refer to children. Thus, the context identification 1030 functionality may map such terms to have a single meaning (e.g., children). Such mappings may be provided for multiple different phrases and corresponding terms. Similarly, synonyms or words related to keywords may also be identified.

Once the context identification 1030 has identified the one or more keywords 1015 and identified the context of the identified keywords 1015, the processing module 1005 may perform a transcription module 1040. The processing module 1005 may determine, based on the identification of the keywords 1015, and the context of the keywords, a corresponding transcribed keyword. Based on predetermined keywords and context, the transcription module 1040 generate transcribed speech data 1045 from the recognized speech data 945. The transcribed speech data 1045 may include speech data that has been transcribed based on the identified keywords and context of the keywords. As noted above, in some embodiments, the transcribed speech data 1045 may be used for translation purposes.

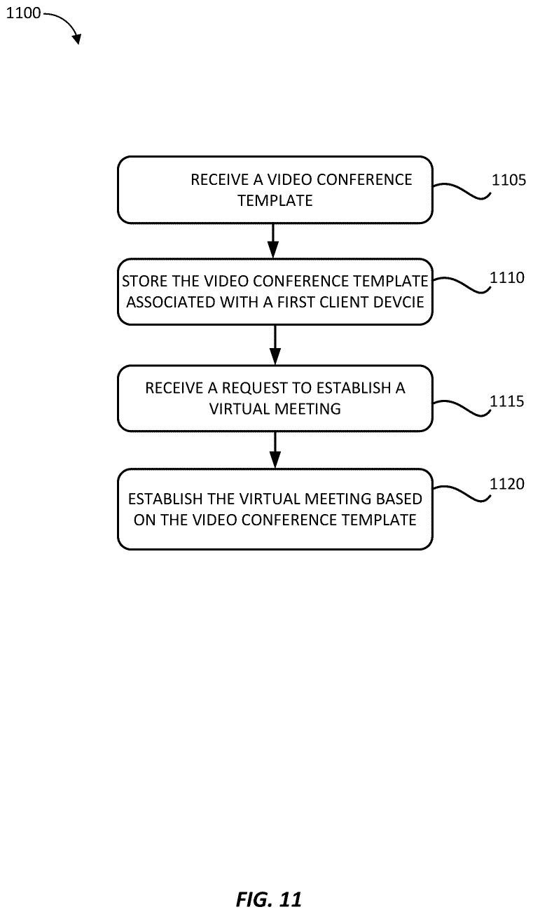

Referring now to FIG. 11, a flowchart of an example method 1100 for providing virtual meeting configuration and execution templates is illustrated, according to an embodiment herein. The description of the method 1100 in FIG. 11 will be made with reference to FIGS. 3-10, however any suitable system according to this disclosure may be used, such as the example systems 100 and 200, shown in FIGS. 1 and 2.

The method 1100 may include steps 1105 and 1110. At step 1105, the method 1100 may include receiving, from a first client device, a video conference template. The video conference template may include one or more settings corresponding to a configuration of a virtual meeting. For example, the video conference provider 310 may receive the template 444 from the client device 340a. At step 1110, the video conference provider may store the video conference template associated with the first client device. For example, the video conference provider 310 may store the template 444 in the template database 350.

The method 1100 may also include steps 1115 and 1120. At step 1115, the method 1100 may include receiving, by the video conference provider, a request to establish a virtual meeting. For example, the client device 340a may transmit a request to the video conference provider 310 to establish a virtual meeting. At step 1120, the video conference provider may establish the virtual meeting based on the video conference template. The virtual meeting may be based on the video conference template and include a plurality of participants. Each of the participants may exchange one or more audio or video streams via the virtual meeting using a plurality of client devices.

In some embodiments, the one or more settings corresponding to the configuration of the virtual meeting may include a meeting format. For example, the meeting format may include a webinar, virtual meeting, virtual concert, or a live-streaming event. In such cases, wherein the one or more settings include a meeting format, the method may include determining, by the video conference provider, the meeting format for the virtual meeting based on the video conference template, and establishing the virtual meeting based on the meeting format.

In other embodiments, the one or more settings corresponding to the configuration of the virtual meeting may include one or more speech recognition settings. In such cases, the method 1100 may include determining, by the video conference provider, the one or more speech recognition settings applicable to the virtual meeting and performing speech recognition during the virtual meeting based on the video conference template. For example, the one or more speech recognition settings may include automated speech captioning of the audio streams exchanged during the virtual meeting, and the method 1100 may include providing, by the video conference provider, automated captioning of the audio streams exchanged during the virtual meeting based on the video conference template. In another example, the one or more speech recognition settings may include translating the one or more audio or video streams using a selected language for speech recognition, and the method 1100 includes translating, by the video conference provider, the one or more audio or video streams using the selected language during the virtual meeting based on the video conference template.

In another embodiment, the one or more settings corresponding to the configuration of the virtual meeting may include a transcription setting for speech recognition performed during the virtual meeting. In such cases, the method 1100 may include providing, by the video conference provider, a transcription of the audio streams exchanged during the virtual meeting based on the transcription setting. In some embodiments, the method 1100 may include receiving, from the first client device, a request to share the video conference template with a second client device and transmitting, by the video conference provider, an indication to the second client device that the video conference template is accessible by the second client device.

In another embodiment, the one or more settings may include one or more multimedia stream settings. In such cases, the method 1100 may include establishing the virtual meeting based on the one or more multimedia stream settings and exchanging the one or more audio or video streams via the virtual meeting using the plurality of client devices based on the multimedia stream settings. For example, the multimedia stream settings may include settings relating to exchange of chat messages, and thus the method 1100 may include exchanging, by the video conference provider, one or more chat messages between the plurality of client devices during the virtual meeting based on the one or more multimedia stream settings of the video conference template. In another example, the method 1100 may include limiting the ability of a subset of the plurality of client devices to interact during the virtual meeting based on the one or more multimedia stream settings. In still another example, the method 1100 may include exchanging one or more audio streams between the plurality of client devices based on the one or more multimedia stream settings of the video conference template. Such a step may include receiving, from a first subset of the plurality of client devices, one or more audio streams, transmitting the one or more audio streams from the first subset of the plurality of client devices to a second subset of the plurality of client devices, and prohibiting the second subset of plurality of client devices from transmitting one or more audio streams to the first subset of the plurality of client devices.

In another embodiment, the one or more settings may include one or more participant settings. In such cases, the method 1100 may include determining, by the video conference provider, an invitation list for the virtual meeting invitation based on the one or more participant settings and transmitting the virtual meeting invitation to the plurality of participants based on the invitation list. The invitation list may include the plurality of participants joined to the virtual meeting. In another embodiment, the one or more settings may include a recording setting. In such a case, the method 1100 may include determining, by the video conference provider, the recording setting for the virtual meeting based on the first video conference template and recording, by the video conference provider, the virtual meeting based on the recording setting.

In some embodiments, the method 1100 may include receiving, from the first client device, a request to generate a second virtual meeting invitation and receiving, by the video conference provider, an indication to set one or more settings of the second virtual meeting invitation based on a second video conference template. The second video conference template may include different settings than the first video conference template. The method 1100 may further include establishing, by the video conference provider, a second virtual meeting based on the second video conference template, where the second virtual meeting includes a second plurality of participants, each participant of the second plurality of participants exchanging one or more audio or video streams via the second virtual meeting using a plurality of client devices and is configured based on one or more settings of the second video conference template.

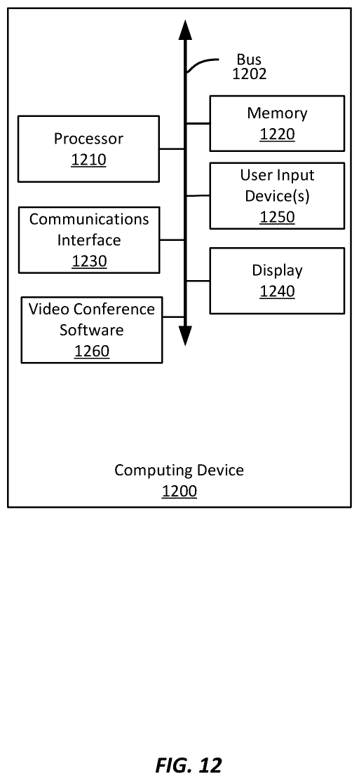

Referring now to FIG. 12, FIG. 12 shows an example computing device 1200 suitable for providing virtual meeting configuration and execution templates. The example computing device 1200 includes a processor 1210 which is in communication with the memory 1220 and other components of the computing device 1200 using one or more communications buses 1202. The processor 1210 is configured to execute processor-executable instructions stored in the memory 1220 to perform one or more methods for providing virtual meeting configuration and execution templates, such as part or all of the example method 1100, described above with respect to FIG. 11. For example, the video conferencing software 1260 provided on the computing device 1200 may provide instructions for performing one or more steps of the method 1100 for providing virtual meeting configuration and execution templates. The computing device, in this example, also includes one or more user input devices 1250, such as a keyboard, mouse, touchscreen, video input device (e.g., one or more cameras), microphone, etc., to accept user input. The computing device 1200 also includes a display 1240 to provide visual output to a user.

The computing device 1200 also includes a communications interface 1230. In some examples, the communications interface 1230 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random-access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### Examples

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification

As used below, any reference to a series of examples is to be understood as a reference to each of those examples disjunctively (e.g., “Examples 1-4” is to be understood as “Examples 1, 2, 3, or 4”).

Example 1 is a method comprising: receiving, from a first client device, a video conference template comprising one or more settings corresponding to a configuration of a virtual meeting; storing, by a video conference provider, the video conference template associated with the first client device; receiving, by the video conference provider, a request to establish a virtual meeting; and establishing, by the video conference provider, the virtual meeting based on the video conference template, the virtual meeting comprising a plurality of participants, each participant of the plurality of participants exchanging one or more audio or video streams via the virtual meeting using a plurality of client devices.

Example 2 is the method of any previous or subsequent Example, wherein the one or more settings corresponding to the configuration of the virtual meeting comprise a meeting format, and the method further comprising: determining, by the video conference provider, the meeting format for the virtual meeting based on the video conference template; and establishing, by the video conference provider, the virtual meeting based on the meeting format.

Example 3 is the method of any previous or subsequent Example, wherein the meeting format comprises one of a webinar, virtual meeting, virtual concert, or a live-streaming event.

Example 4 is the method of any previous or subsequent Example, the method further comprising: receiving, from the first client device, a request to share the video conference template with a second client device; and transmitting, by the video conference provider, an indication to the second client device that the video conference template is accessible by the second client device.

Example 5 is the method of any previous or subsequent Example, wherein the one or more settings corresponding to the configuration of the virtual meeting comprise one or more speech recognition settings, and the method further comprising: determining, by the video conference provider, the one or more speech recognition settings applicable to the virtual meeting; and performing, by the video conference provider, speech recognition during the virtual meeting based on the video conference template.

Example 6 is the method of any previous or subsequent Example, wherein the one or more speech recognition settings comprises automated captioning of the audio streams exchanged during the virtual meeting, and the method further comprises: providing, by the video conference provider, automated captioning of the audio streams exchanged during the virtual meeting based on the video conference template.

Example 7 is the method of any previous or subsequent Example, wherein the one or more speech recognition settings comprises translating the one or more audio or video streams using a selected language for speech recognition performed during the virtual meeting, and the method further comprises: translating, by the video conference provider, the one or more audio or video streams using the selected language during the virtual meeting based on the video conference template.

Example 8 is the method of any previous or subsequent Example, wherein the one or more settings corresponding to the configuration of the virtual meeting comprise a transcription setting for speech recognition performed during the virtual meeting, and the method further comprises: providing, by the video conference provider, a transcription of the audio streams exchanged during the virtual meeting based on the transcription setting.

Example 9 is a system comprising: a non-transitory computer-readable medium; a communications interface; and a processor communicatively coupled to the non-transitory computer-readable medium and the communications interface, the processor configured to execute processor-executable instructions stored in the non-transitory computer-readable medium to: receive, from a first client device, a video conference template comprising one or more settings corresponding to a configuration of a virtual meeting; store, by a video conference provider, the video conference template associated with the first client device; receive, by the video conference provider, a request to generate a virtual meeting invitation; and establish, by the video conference provider, a virtual meeting based on the video conference template, the virtual meeting comprising a plurality of participants, each participant of the plurality of participants exchanging one or more audio or video streams via the virtual meeting using a plurality of client devices.

Example 10 is the system of any previous or subsequent Example, wherein the one or more settings comprise one or more multimedia stream settings, and wherein the processor is further configured to execute processor-executable instructions stored in the non-transitory computer-readable medium to: establish, by the video conference provider, the virtual meeting based on the one or more multimedia stream settings; and exchange, by the video conference provider, the one or more audio or video streams via the virtual meeting using the plurality of client devices based on the multimedia stream settings.

Example 11 is the system of any previous or subsequent Example, wherein the processor is further configured to execute processor-executable instructions stored in the non-transitory computer-readable medium to: exchange, by the video conference provider, one or more chat messages between the plurality of client devices during the virtual meeting based on the one or more multimedia stream settings of the video conference template.

Example 12 is the system of any previous or subsequent Example, wherein the processor is further configured to execute processor-executable instructions stored in the non-transitory computer-readable medium to: limit, by the video conference provider, the ability of a subset of the plurality of client devices to interact during the virtual meeting based on the one or more multimedia stream settings.

Example 13 is the system of any previous or subsequent Example, wherein the one or more settings comprise one or more participant settings, and wherein the processor is further configured to execute processor-executable instructions stored in the non-transitory computer-readable medium to: determine, by the video conference provider, an invitation list for the virtual meeting invitation based on the one or more participant settings, wherein the invitation list comprises the plurality of participants; and transmit the virtual meeting invitation to the plurality of participants based on the invitation list.

Example 14 is the system of any previous or subsequent Example, wherein the processor is further configured to execute processor-executable instructions stored in the non-transitory computer-readable medium to: receive, from the first client device, a request to share the video conference template with a second client device; and transmit, by the video conference provider, an indication to the second client device that the video conference template is accessible by the second client device.

Example 15 is a non-transitory computer-readable medium comprising processor-executable instructions configured to cause one or more processors to: receive, from a first client device, a first video conference template comprising one or more settings corresponding to a configuration of a virtual meeting; store, by a video conference provider, the first video conference template associated with the first client device; receive, by the video conference provider, a request to generate a virtual meeting invitation; and establish, by the video conference provider, a virtual meeting based on the first video conference template, the virtual meeting comprising a plurality of participants, each participant of the plurality of participants exchanging one or more audio or video streams via the virtual meeting using a plurality of client devices.

Example 16 is the non-transitory computer-readable medium of any previous or subsequent Example, wherein the one or more settings comprise one or more multimedia stream settings, and wherein the processor is further configured to execute processor-executable instructions stored in the non-transitory computer-readable medium to: exchange, by the video conference provider, one or more audio streams between the plurality of client devices based on the one or more multimedia stream settings of the first video conference template.

Example 17 is the non-transitory computer-readable medium of any previous or subsequent Example, wherein: the instructions to exchange, by the video conference provider, the one or more audio streams between the plurality of client devices based on the one or more multimedia stream settings of the first video conference template cause the processor to execute further processor-executable instructions stored in the non-transitory computer-readable medium to: receive, from a first subset of the plurality of client devices, one or more audio streams; transmit, by the video conference provider, the one or more audios streams from the first subset of the plurality of client devices to a second subset of the plurality of client devices; and prohibit, by the video conference provider, the second subset of the plurality of client devices from transmitting one or more audio streams to the first subset of the plurality of client devices.

Example 18 is the non-transitory computer-readable medium of any previous or subsequent Example, wherein the processor is further configured to execute processor-executable instructions stored in the non-transitory computer-readable medium to: receive, from the first client device, a request to generate a second virtual meeting invitation; receive, by the video conference provider, an indication to set one or more settings of the second virtual meeting invitation based on a second video conference template, wherein the second video conference template comprises different settings than the first video conference template; and establish, by the video conference provider, a second virtual meeting based on the second video conference template, wherein the second virtual meeting: comprises a second plurality of participants, each participant of the second plurality of participants exchanging one or more audio or video streams via the second virtual meeting using a plurality of client devices; and is configured based on one or more settings of the second video conference template.

Example 19 is the non-transitory computer-readable medium of any previous or subsequent Example, wherein the one or more settings corresponding to the configuration of the virtual meeting comprise a meeting format, and wherein the processor is further configured to execute processor-executable instructions stored in the non-transitory computer-readable medium to: determine, by the video conference provider, the meeting format for the virtual meeting based on the first video conference template; and establish, by the video conference provider, the virtual meeting based on the meeting format.

Example 20 is the non-transitory computer-readable medium of any previous or subsequent Example, wherein the one or more settings corresponding to the configuration of the virtual meeting comprise a recording setting, and wherein the processor is further configured to execute processor-executable instructions stored in the non-transitory computer-readable medium to: determine, by the video conference provider, the recording setting for the virtual meeting based on the first video conference template; and record, by the video conference provider, the virtual meeting based on the recording setting.

1. A method comprising:
receiving, by a video conference provider from a first client device, a request to generate a video conference template and a meeting format;
providing, to the first client device, a plurality of prompts and a corresponding plurality of settings, at least a subset of the plurality of settings pre-populated based on the meeting type;
receiving, from the first client device, the plurality of settings indicating a configuration of a virtual meeting;
storing, by a video conference provider, a video conference template associated with the first client device based on the received plurality of settings;
receiving, by the video conference provider, a request to establish a virtual meeting and an identification of the video conference template; and
establishing, by the video conference provider, the virtual meeting based on the video conference template, the virtual meeting comprising a plurality of participants, each participant of the plurality of participants exchanging one or more audio or video streams via the virtual meeting using a plurality of client devices.

2. The method of claim 1, wherein the one or more settings corresponding to the configuration of the virtual meeting comprise a meeting format, and the method further comprising:
determining, by the video conference provider, the meeting format for the virtual meeting based on the video conference template; and
establishing, by the video conference provider, the virtual meeting based on the meeting format.

3. The method of claim 2, wherein the meeting format comprises one of a webinar, virtual meeting, virtual concert, or a live-streaming event.

4. The method of claim 1, the method further comprising:
receiving, from the first client device, a request to share the video conference template with a second client device; and
transmitting, by the video conference provider, an indication to the second client device that the video conference template is accessible by the second client device.

5. The method of claim 1, wherein the one or more settings corresponding to the configuration of the virtual meeting comprise one or more speech recognition settings, and the method further comprising:
determining, by the video conference provider, the one or more speech recognition settings applicable to the virtual meeting; and
performing, by the video conference provider, speech recognition during the virtual meeting based on the video conference template.

6. The method of claim 5, wherein the one or more speech recognition settings comprises automated captioning of the audio streams exchanged during the virtual meeting, and the method further comprises:
providing, by the video conference provider, automated captioning of the audio streams exchanged during the virtual meeting based on the video conference template.

7. The method of claim 5, wherein the one or more speech recognition settings comprises translating the one or more audio or video streams using a selected language for speech recognition performed during the virtual meeting, and the method further comprises:
translating, by the video conference provider, the one or more audio or video streams using the selected language during the virtual meeting based on the video conference template.

8. The method of claim 1, wherein the one or more settings corresponding to the configuration of the virtual meeting comprise a transcription setting for speech recognition performed during the virtual meeting, and the method further comprises:
providing, by the video conference provider, a transcription of the audio streams exchanged during the virtual meeting based on the transcription setting.

9. A system comprising:
a non-transitory computer-readable medium;
a communications interface; and
a processor communicatively coupled to the non-transitory computer-readable medium and the communications interface, the processor configured to execute processor-executable instructions stored in the non-transitory computer-readable medium to:
receive, by a video conference provider from a first client device, a request to generate a video conference template and a meeting format;
provide, to the first client device, a plurality of prompts and a corresponding plurality of settings, at least a subset of the plurality of settings pre-populated based on the meeting type;
receive, from the first client device, the plurality of settings indicating a configuration of a virtual meeting;
store, by a video conference provider, a video conference template associated with the first client device based on the received plurality of settings;
receive, by the video conference provider, a request to establish a virtual meeting and an identification of the video conference template; and
establish, by the video conference provider, a virtual meeting based on the video conference template, the virtual meeting comprising a plurality of participants, each participant of the plurality of participants exchanging one or more audio or video streams via the virtual meeting using a plurality of client devices.

10. The system of claim 9, wherein the one or more settings comprise one or more multimedia stream settings, and wherein the processor is further configured to execute processor-executable instructions stored in the non-transitory computer-readable medium to:
establish, by the video conference provider, the virtual meeting based on the one or more multimedia stream settings; and
exchange, by the video conference provider, the one or more audio or video streams via the virtual meeting using the plurality of client devices based on the multimedia stream settings.

11. The system of claim 10, wherein the processor is further configured to execute processor-executable instructions stored in the non-transitory computer-readable medium to:
exchange, by the video conference provider, one or more chat messages between the plurality of client devices during the virtual meeting based on the one or more multimedia stream settings of the video conference template.

12. The system of claim 10, wherein the processor is further configured to execute processor-executable instructions stored in the non-transitory computer-readable medium to:
limit, by the video conference provider, the ability of a subset of the plurality of client devices to interact during the virtual meeting based on the one or more multimedia stream settings.

13. The system of claim 9, wherein the one or more settings comprise one or more participant settings, and wherein the processor is further configured to execute processor-executable instructions stored in the non-transitory computer-readable medium to:
determine, by the video conference provider, an invitation list for the virtual meeting invitation based on the one or more participant settings, wherein the invitation list comprises the plurality of participants; and
transmit the virtual meeting invitation to the plurality of participants based on the invitation list.

14. The system of claim 9, wherein the processor is further configured to execute processor-executable instructions stored in the non-transitory computer-readable medium to:
receive, from the first client device, a request to share the video conference template with a second client device; and
transmit, by the video conference provider, an indication to the second client device that the video conference template is accessible by the second client device.

15. A non-transitory computer-readable medium comprising processor-executable instructions configured to cause one or more processors to:
receive, by a video conference provider from a first client device, a request to generate a video conference template and a meeting format;
provide, to the first client device, a plurality of prompts and a corresponding plurality of settings, at least a subset of the plurality of settings pre-populated based on the meeting type;
receive, from the first client device, the plurality of settings indicating a configuration of a virtual meeting;
store, by a video conference provider, a video conference template associated with the first client device based on the received plurality of settings;
receive, by the video conference provider, a request to establish a virtual meeting and an identification of the video conference template; and
establish, by the video conference provider, a virtual meeting based on the video conference template, the virtual meeting comprising a plurality of participants, each participant of the plurality of participants exchanging one or more audio or video streams via the virtual meeting using a plurality of client devices.

16. The non-transitory computer-readable medium of claim 15, wherein the one or more settings comprise one or more multimedia stream settings, and wherein the processor is further configured to execute processor-executable instructions stored in the non-transitory computer-readable medium to:
exchange, by the video conference provider, one or more audio streams between the plurality of client devices based on the one or more multimedia stream settings of the first video conference template.

17. The non-transitory computer-readable medium of claim 16, wherein:
the instructions to exchange, by the video conference provider, the one or more audio streams between the plurality of client devices based on the one or more multimedia stream settings of the first video conference template cause the processor to execute further processor-executable instructions stored in the non-transitory computer-readable medium to:
receive, from a first subset of the plurality of client devices, one or more audio streams;
transmit, by the video conference provider, the one or more audios streams from the first subset of the plurality of client devices to a second subset of the plurality of client devices; and
prohibit, by the video conference provider, the second subset of the plurality of client devices from transmitting one or more audio streams to the first subset of the plurality of client devices.

18. The non-transitory computer-readable medium of claim 15, wherein the processor is further configured to execute processor-executable instructions stored in the non-transitory computer-readable medium to:
receive, from the first client device, a request to generate a second virtual meeting invitation;
receive, by the video conference provider, an indication to set one or more settings of the second virtual meeting invitation based on a second video conference template, wherein the second video conference template comprises different settings than the first video conference template; and
establish, by the video conference provider, a second virtual meeting based on the second video conference template, wherein the second virtual meeting:
comprises a second plurality of participants, each participant of the second plurality of participants exchanging one or more audio or video streams via the second virtual meeting using a plurality of client devices; and
is configured based on one or more settings of the second video conference template.

19. The non-transitory computer-readable medium of claim 15, wherein the one or more settings corresponding to the configuration of the virtual meeting comprise a meeting format, and wherein the processor is further configured to execute processor-executable instructions stored in the non-transitory computer-readable medium to:
determine, by the video conference provider, the meeting format for the virtual meeting based on the first video conference template; and
establish, by the video conference provider, the virtual meeting based on the meeting format.

20. The non-transitory computer-readable medium of claim 19, wherein the one or more settings corresponding to the configuration of the virtual meeting comprise a recording setting, and wherein the processor is further configured to execute processor-executable instructions stored in the non-transitory computer-readable medium to:
determine, by the video conference provider, the recording setting for the virtual meeting based on the first video conference template; and
record, by the video conference provider, the virtual meeting based on the recording setting.
